(19) United States
(12) Patent Application Publication
(10) Pub. No.: US 2006/0224503 A1
(43) Pub. Date: Oct. 5, 2006

(54) Integrated online help system and buyer-initiated C2C marketplace

(76) Inventor: Chun R. Luo, Farmington, CT (US)

Correspondence Address: CHUN R. LUO, 17 WEST GATE RD., FARMINGTON, CT, 06032, US

(21) Appl. No.: 10/907,554

(22) Filed: Apr. 5, 2005

(51) Int. Cl. G06Q 99/00; G06Q 30/00; G06Q 40/00

(52) U.S. Cl. 705/39; 705/1; 705/26; 705/35

(57) ABSTRACT

An integrated online help system and buyer-initiated C2C marketplace. A client who is in need of help posts a request (Goods Wanted or Info Wanted) at a client system, including a detailed description of the request and the fees to be paid. The server system notifies a selected group of registered help providers about the request via email. Other users can search at the client system for any open requests and post responses if desired. The help providers are asked to enter a “guaranteed refund rate” in their response to facilitate transactions involving merchandise. A set of four methods and procedures support the irreversible transaction involving information. The help providers are required to provide their “help credentials”, their response's “projected satisfaction index”, which has an inverse relation to the requester's “minimum pay rate”. The requester is required to sign a “contract”, agreeing to the minimum pay rate prior to viewing each response. This online help community, a buyer-initiated C2C online marketplace, is regulated by a user agreement and a peer rating system.

### TECHNICAL FIELD

This invention relates to an integrated method and system for requesting and delivering help with goods and information via the Internet, and more broadly to a system and method for creating a buyer-initiated Consumer-to-Consumer (C2C) online marketplace for goods and information.

### BACKGROUND OF THE INVENTION

The Internet and e-commerce have been growing rapidly. According to the U.S. Department of Commerce, online e-commerce sales surpassed $55 billion in the U.S. in 2003, and $69 billion in 2004. Forrester Research projected that by 2010, online sales will reach $331 billion, and between 2004 and 2010, online sales will grow at a 15% compound annual growth rate. The three largest categories in 2010 will be travel ($119 billion), home products ($43 billion), and apparel ($28 billion). The analysts estimated that about twenty percent of all online sales occurred business-to-consumer (B2C), forty percent business-to-business (B2B), and forty percent through consumer-to-consumer (C2C) seller marketplaces (e.g., eBay, Yahoo Auction, etc).

Consumers play a rather passive role in this seller-dominated e-commerce environment. Every consumer, now and then, has experienced the frustration of getting lost in the cyberspace in attempting to find a perfect online store for their needs. Another problem is that there is nowhere to go if you need some special merchandise or a rare, hard-to-find item. What if you need an old comic book that you have not been able to find on Amazon.com or any other online book stores? What if you need an old music CD by one of your favorite rock stars? There are currently no major, centralized online marketplaces for serving this kind of need. According to TowerGroup Research, the demand for consumer-initiated C2B and C2C business is expected to increase significantly in the near future. However, it is a challenge to construct C2B or C2C e-commerce systems because of their diverse nature.

Priceline.com pioneered a C2B online marketplace where consumers are allowed to make reservations on travel related services (e.g., airline tickets, hotel reservations, car rentals) at a price they name. This approach is innovative but requires lining up participating merchants and retailers in order to provide services in any given categories. In theory, this model can be used for the retailers to sell any overstocked goods or last minute services. In reality, it is difficult to find the retailers who are willing to participate because of profitability concerns. That is why Priceline.com now focuses solely on travel related services.

Given the wide differences in individual consumers' needs and the growing trend for individual styles and customization, coupled with consumers' limited time, there is a potentially tremendous need for a centralized, buyer-initiated online marketplace for goods where anyone can request for specific merchandise, at a price they are willing to pay. Unlike Priceline's C2B business model, a buyer-initiated C2C marketplace will eliminate the need to line up participating merchants. The help will come from other consumers instead. This model is well suited for serving the need of individual consumers for special merchandise or rare, hard-to-find items.

More remarkable, in this information age there are no major, centralized online marketplaces for serving people's need for informational help. Many, if not all of us, have had technical or personal questions and problems that we wish there is a place we could turn for help, for a reasonable fee. Although there are many discussion forums on the Internet, they are all topic-specific and are dedicated to serving special populations and interest groups. Also because they are free discussion forums, the request for help is often not answered, answered late, or answered incompletely.

Given the status of the matter concerning help with goods and information, there is a potentially tremendous need for a centralized, buyer-initiated C2C online marketplace where anyone can request help for special merchandise or information, at a price they are willing to pay.

### SUMMARY OF THE INVENTION

It is therefore an object of this invention to provide an integrated method and system for requesting and delivering help with goods and information via the Internet.

It is a further object of this invention to provide such a system that creates a buyer-initiated C2C marketplace for goods.

It is a further object of this invention to provide such a system, which creates a buyer-initiated C2C marketplace for information.

It is a further object of this invention to provide such a system which allows users to post a request, update the request, and take actions on each of the responses received.

It is a further object of this invention to provide such a system, which allows help providers (or sellers) to search for any open requests and post their responses to qualify for payments if their responses are accepted (or their answers are viewed) by the requesters.

It is a further object of this invention to provide such a system which enables electronic notifications to both help requesters and providers on their counterparts' activities concerting the request.

It is a further object of this invention to provide such a system, which allows peer ratings to help regulate user activities.

As a result, this invention presents an integrated method and system for requesting and delivering help with goods and information. This system has the following components: (a) a system and the associated Web site for the user to post a help request, identified by request type (Goods Wanted or Info Wanted), category, the fees to be paid, and a detailed description of the request; (b) a system for help providers to search for open requests and post a response; (c) a system for both help requesters and providers to update their requests and responses; (d) a set of methods and procedures to support the irreversible transaction involving information; (e) a system for the requester to accept, reject, or ask for clarification on each of the the responses received; (f) a messaging system to notify the help requester and provider regarding their counterparts' activities concerning the request; (g) a payment system for the help requester to disburse payment to the help providers whose responses have been accepted or viewed; (h) and a peer rating system for regulating user activities.

This invention results from the realization that an innovative, integrated system is needed for requesting and delivering help with goods and information, and more broadly for creating a centralized, buyer-initiated C2C online marketplace for goods and information. This system brings together individual consumers who need help and those who can help.

### BRIEF DESCRIPTION OF THE SEVERAL VIEWS OF DRAWINGS

Other objects, features and advantages will occur to those skilled in the art from the following description of a preferred embodiment and the accompanying drawings, in which:

FIG. 1 shows a simplified use case model, which this invention is intended to realize and support;

FIG. 2A-2C shows a diagram of the primary components associated with one embodiment of the integrated help system, including the associated Web site components in accordance with this invention;

FIG. 3 shows the class diagram of the system design associated with this embodiment;

FIG. 4 shows the database design consisting of relational database tables in support of this system;

FIG. 5 shows a Web site's homepage associated with this embodiment of the system;

FIG. 6A-6C shows the registration process required for users intended to post requests and responses;

FIG. 7 shows the sign in process required for registered users to post requests and responses;

FIG. 8A-8B shows the process of posting a request on the system;

FIG. 9A-9B shows the process of a user searching for open requests on the system;

FIG. 10 shows the process of a user viewing an open request by following a link from a notification email;

FIG. 11A-11B shows how a user can browse the Web site to find an open request of interest, organized by help types and categories;

FIG. 12A-12C shows the process of posting a response on the system;

FIG. 13A-13D shows how users can manage the personal account in relation to their posted requests and responses;

FIG. 14A-14C shows the process of the user viewing a response to his/her request;

FIG. 15A-15B shows how a help requester takes actions on the responses;

FIG. 16A-16C shows how a help requester disburses payment to help providers after accepting their responses;

FIG. 17A-17B shows the notification emails from the messaging system;

FIG. 18A-18C shows the peer rating process.

### DETAILED DESCRIPTION OF THE INVENTION

This invention presents an integrated method and system for requesting and delivering help with goods and information via the Internet, and more broadly a system and method for creating a buyer-initiated C2C online marketplace for goods and information. A person who is in need of help posts a request at a client system, including a detailed description of the request and the fees to be paid. Help requests are classified into two types: Goods Wanted and Info Wanted. Goods Wanted are requests for special merchandise or any hard-to-find items in various common categories. Info Wanted are requests for information on certain subject matters or answers to technical and personal questions such as legal advice, computer help, and relationship counseling. The server system receives and stores the request in the database. The server system notifies a selected group of registered help providers about the request via email where a link allows them to view the open request and post a response if interested. Other prospective help providers can search at the client system for any open requests and post responses if desired. The help requester is notified as soon as a response is posted.

To facilitate help requester's decision involving merchandise, the help providers are asked to provide a “guaranteed refund rate” for their goods in their response. It can range from 0 to 100 percent.

A set of four methods and procedures were developed to support the delivery of Info Wanted help and the irreversible transaction involving information. The first method was developed for help providers to derive a “projected satisfaction index” for their responses to Info Wanted help requests. The projected satisfaction index is based on the help provider's own confidence rating of his or her response. The help provider is asked to indicate how confident his or her response will be correct (i.e., meet the requester's needs, solve their problems, etc) on a scale of 50 to 100, with 50 being a 50-50 chance and 100 being 100% sure). They are told that this rating will determine the minimum pay rate at which the requester will have to pay if their response is viewed.

The second method and procedure was developed to calculate the minimum pay rate on the basis of the projected satisfaction index as provided by the help provider:
minimum pay rate=100−projected satisfaction index,
which means a minimum pay rate of 0 percent if the response with a projected satisfaction index of 100 was found to be unacceptable; a minimum pay rate of 25 percent if the response with a projected satisfaction index of 75 found to be unacceptable; and a minimum pay rate of 50 percent if the response with a projected satisfaction index of 50 found to be unacceptable. The minimum pay rate applies only to the case where a response is rejected. The help requester is obligated to pay the full amount (100 percent) if a response is accepted.

The dynamics and the inverse relation between the projected satisfaction index and the minimum pay rate facilitate transactions involving information. It keeps the help providers from over-estimating the potential satisfaction of their responses. It reduces the risk of a help requester selecting and viewing the unwanted or incorrect responses.

The third procedure was developed for the help provider to show their help credentials to convince the help requester that his or her response is correct or meets the need. The help provider is asked to enter anything in the “help credentials” field that can increase help requester's confidence in his/her response such as professional credentials, educational background, and work experience. In junction with the projected satisfaction index, they further reduce the risk of a help requester selecting and viewing the unwanted or incorrect responses.

The fourth method and procedure was developed for the help requester to sign a “contract” with the help provider, prior to viewing his or her response. The contract requires the help provider to pay a minimum amount based on the minimum pay rate described above in case the response is deemed unacceptable, and to pay the full amount in case the response is accepted. The contract also serves as a commitment on the requester's part to work with the help provider in case a follow-up is needed for a complete resolution. The requester will not be able to sign another contract to view another response until the current contract is terminated by rejecting the current response and paying the minimum amount. The requester will need to detail their reasons for their rejections.

Upon signing the contract, the help requesters can view the corresponding response and take appropriate actions. They can accept, reject, or ask for clarification on each of the responses received, and then pay the help provider via the payment system. This online help community, a buyer-initiated consumer-to-consumer online marketplace, is regulated by a user agreement and a peer rating system.

The following detailed description provides a demonstration of one preferred embodiment of the invention. However, it is not intended that the invention be limited to this embodiment.

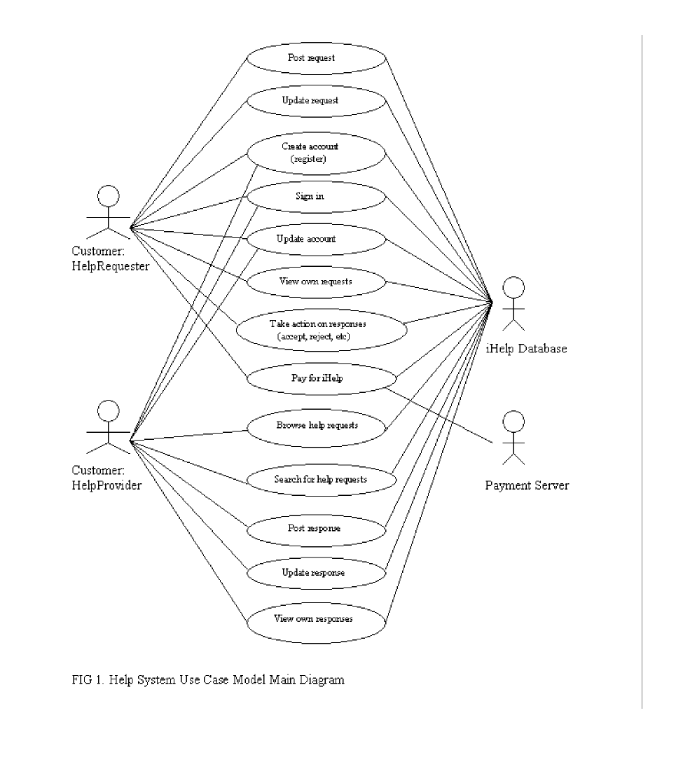

FIG. 1 illustrates a high level system use case model showing how the users (help requesters and help providers) interact with the system and the interrelationships among the major entities, including the database system and the payment system.

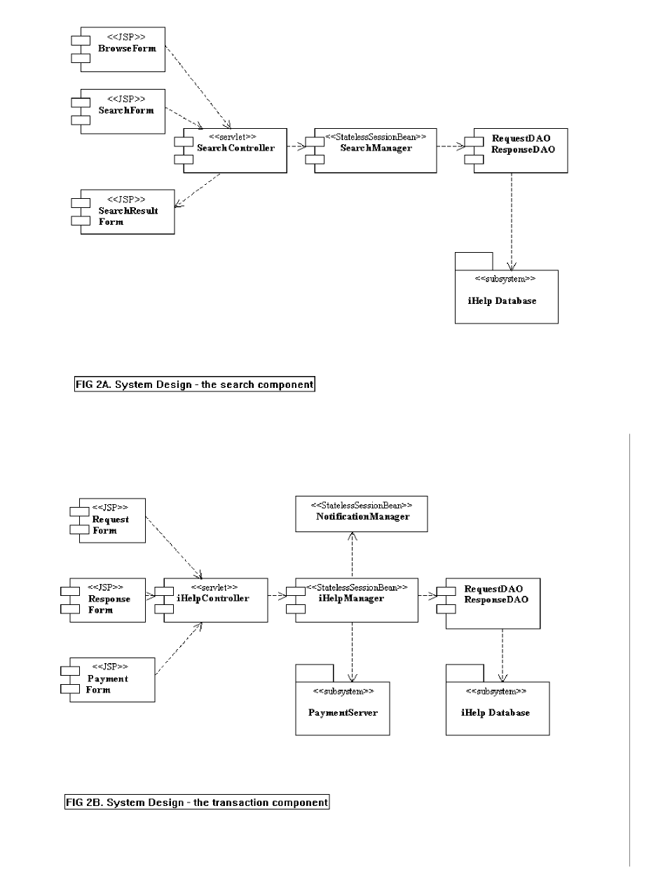

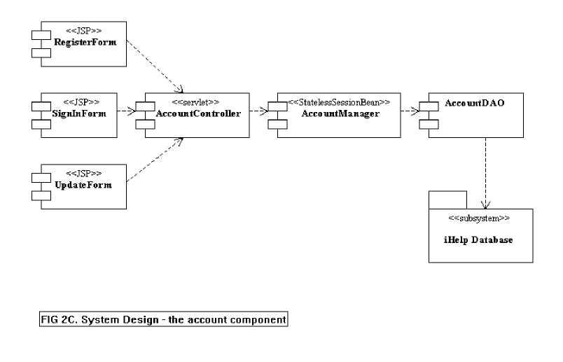

FIG. 2A-2C illustrates the design of the system by showing the three logical components of the system: search component, transaction component, and account component. The search component supports all use cases related to browsing and searching for open help requests. The transaction component provides support for posting requests, posting responses, updating requests, updating responses, requester taking actions on the responses, and disbursing payments, as well as a messaging system for notification and communications between help requesters and help providers. The account component provides support for user registration, user authentication, user preferences, and the management of user accounts. As shown in these diagrams, the architecture of the system is based on Java technology (J2EE). It uses JavaServerPage (JSP) to construct user interfaces and Java Servlet to transmit user requests to the servers (Enterprise Java Beans, EJBs for short), which communicate with a relational database system.

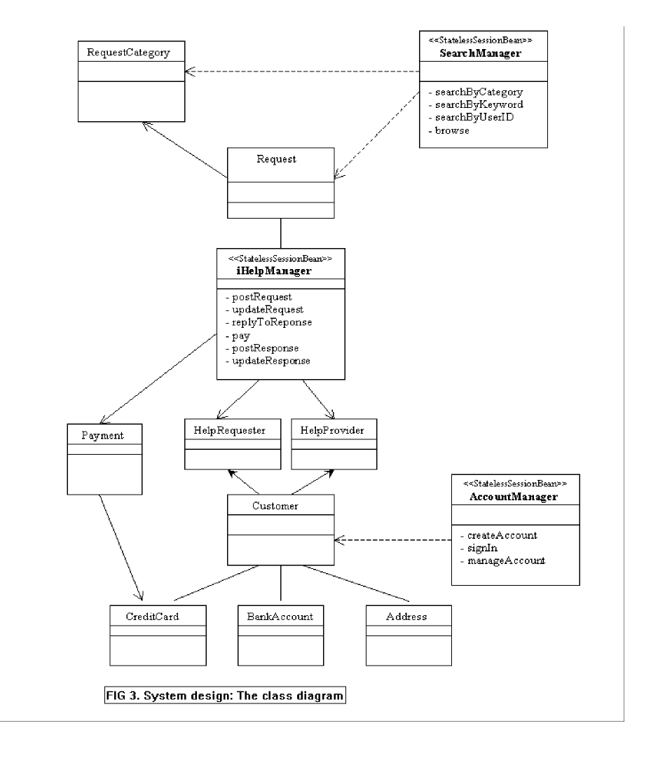

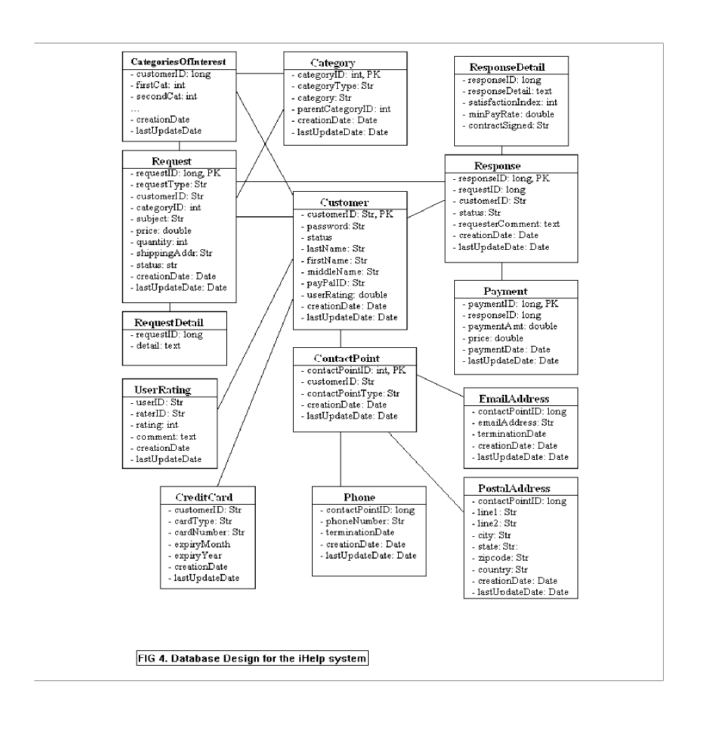

FIG. 3 shows the class diagram for the major server components and their interrelationships. FIG. 4 shows the database design in support of the system. The server components are currently supported by the JRUN4 platform while the database is implemented using MYSQL database.

FIG. 5 shows a Web site's homepage as a result of implementing the system according to the system design and specifications outlined above. There are two broad help categories: Goods Wanted and Info Wanted. From this page, the help requester can register to create a personal account, sign in as a registered user, and post a help request by clicking Post Goods Wanted or Post Info Wanted. Similarly, the help providers can register, sign in, and post help responses. They can browse the open requests by clicking the request categories of interest or search for open requests in specific categories using keyword search. They may also receive email notifications on an open request where they can click a link to view the request and post responses if interested. The homepage also has a section called “Featured Requests” to highlight some of the more interesting requests, and a section called “Request of the Day” to highlight the most interesting one among them.

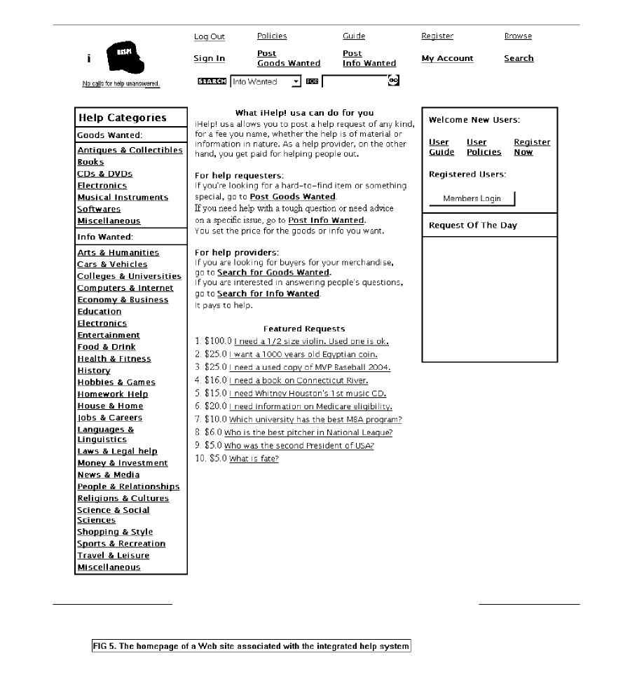

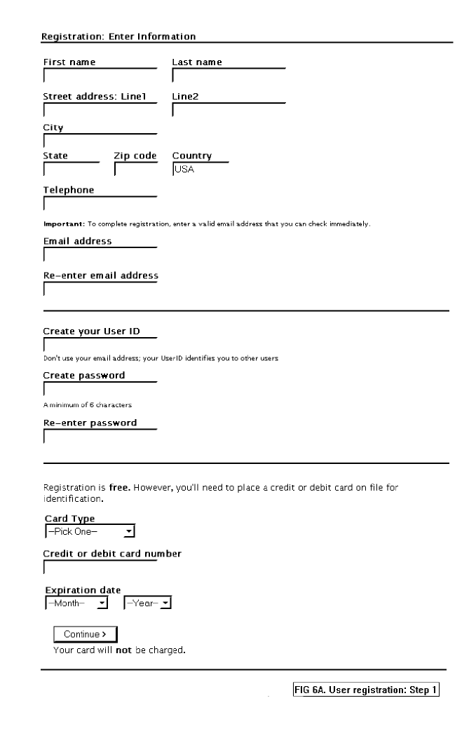

FIG. 6A-6C shows the registration process required for users intended to post requests and responses. The users are asked to provide their contact information, including an email address. They will choose a User ID and password for their account. They are also asked to enter credit card information for the purpose of age verification. The users also choose those help categories of interest for notification purposes. The users are also required to sign a privacy statement. Finally, the users confirm their email to complete the registration process.

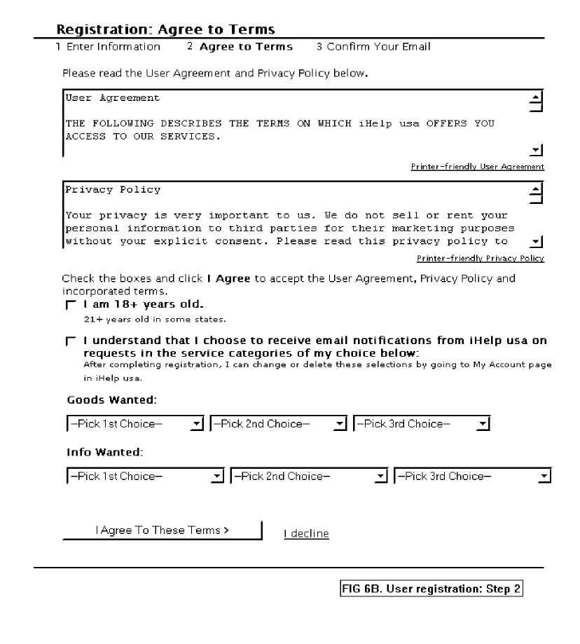

FIG. 7 shows the sign in process required for the registered users to post requests or responses. They may recover User ID or password in case they forgot them.

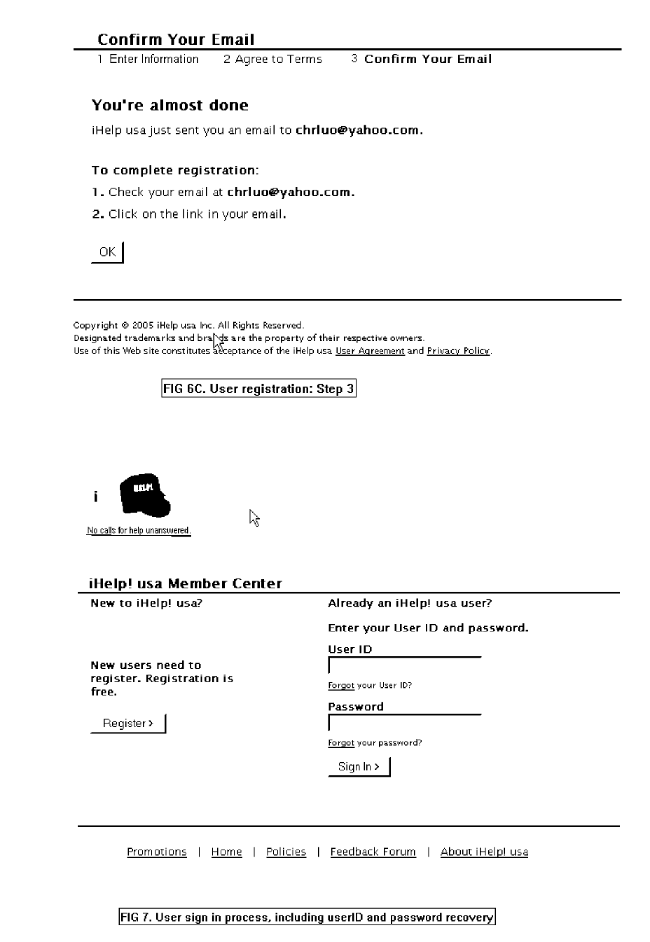

FIG. 8A-8B shows the process of posting a request on the system. The user initiates the process by selecting either Post Goods Wanted or Post Info Wanted. For both requests, the requester is required to provide a detail description of the request, a short subject line, and the category this request falls in, and the price to be paid. For Goods Wanted request, the user is also asked to enter the quantity and a shipping address if it is different than the postal address.

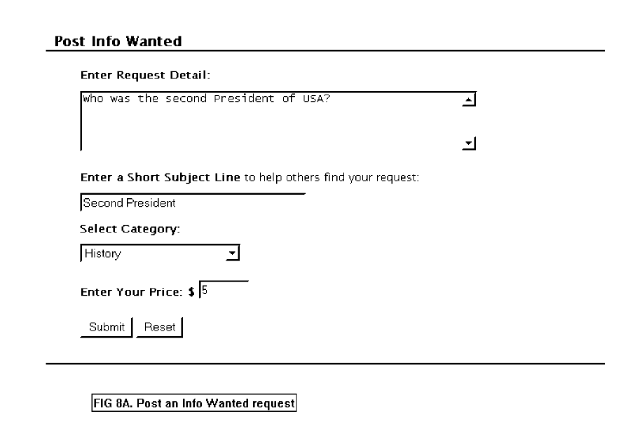

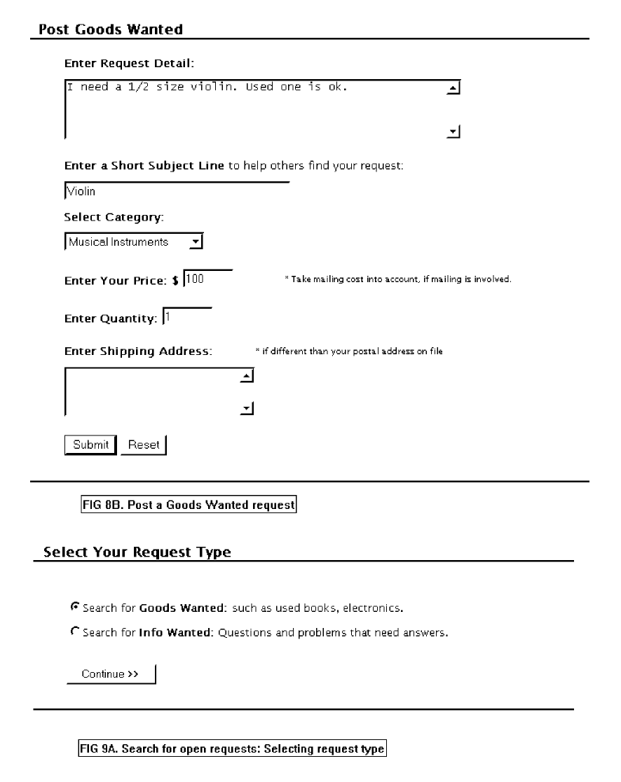

FIG. 9A-9B shows the process of a user searching for open requests on the system. The user first selects a request type of interest and then performs search by keyword, by request category, or by both. FIG. 9C shows the search results, in summary format, and FIG. 9D shows the request details and any existing responses after the user clicks the request summary of interest.

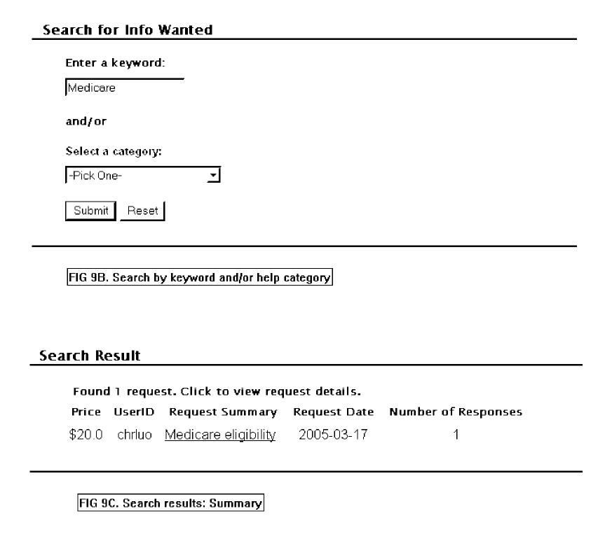

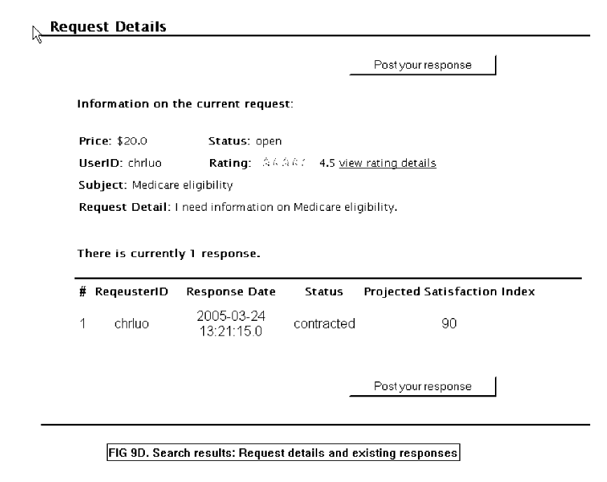

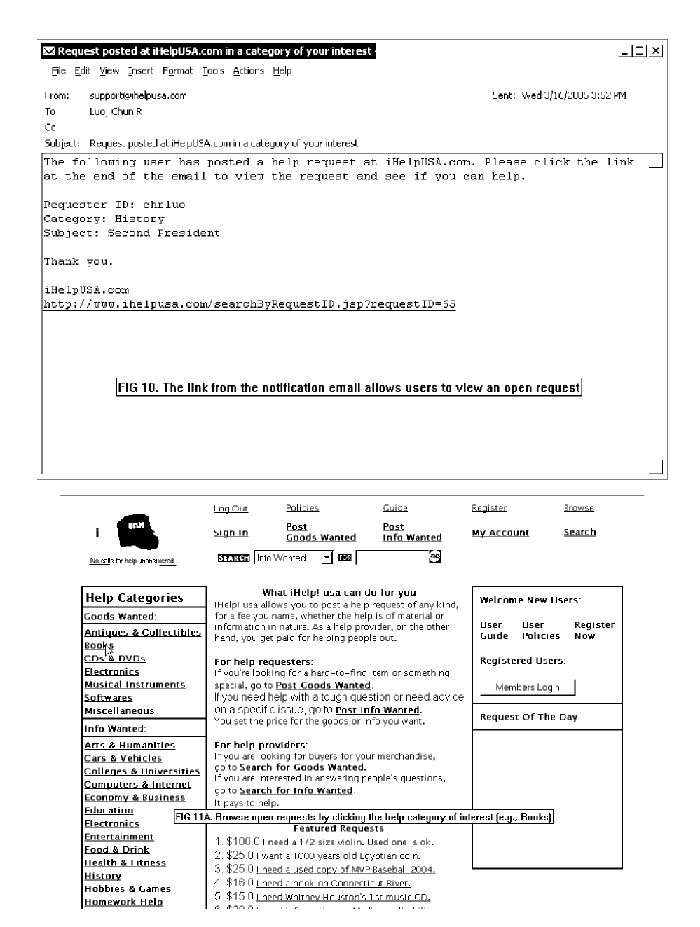

FIG. 10 shows the process of a user viewing an open request by clicking a link from a notification email. Each time when a new request is posted on the Web site, a group of potential help providers are notified via email. They are selected on the basis of their preferred help categories of interest as selected at the time of registration, which can be updated anytime by going to their user accounts.

FIG. 11A-11B shows how a user browses the Web site to find an open request of interest, organized by help types and categories.

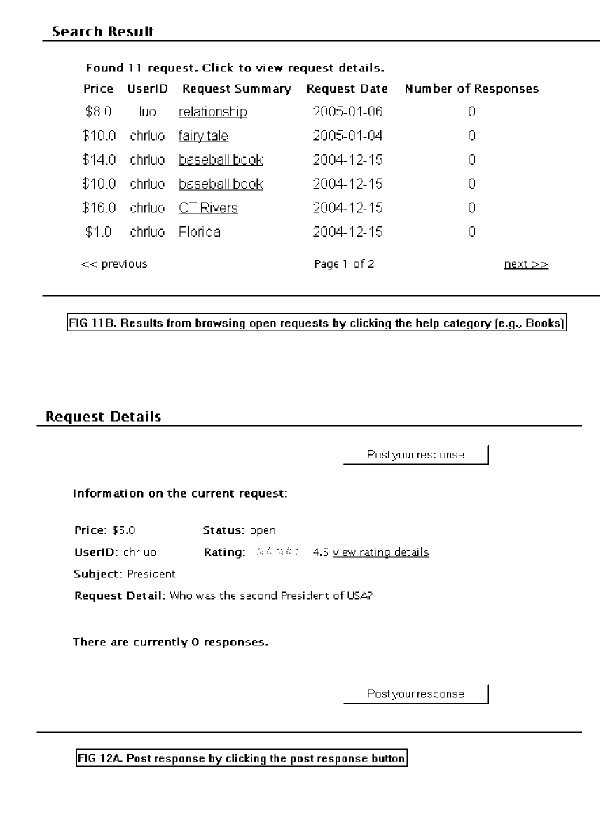

FIG. 12A shows the process of starting posting a response on the system. The help providers search and select the request of interest to respond. To post a response, the user is required to enter a detailed description of their response and an account for them to receive payment. For the Goods Wanted requests, the responders are asked to enter a “guaranteed refund rate” to facilitate transactions involving merchandise, as shown in FIG. 12B. The rate ranges from 0 to 100 percent. For the Info Wanted requests, the responders are required to enter their help credentials to allow the requester to better determine the correctness or suitability of their response, as shown in FIG. 12C. They are also asked to enter a Projected Satisfaction Index (PSI) for their response on the basis of their confidence on the response.

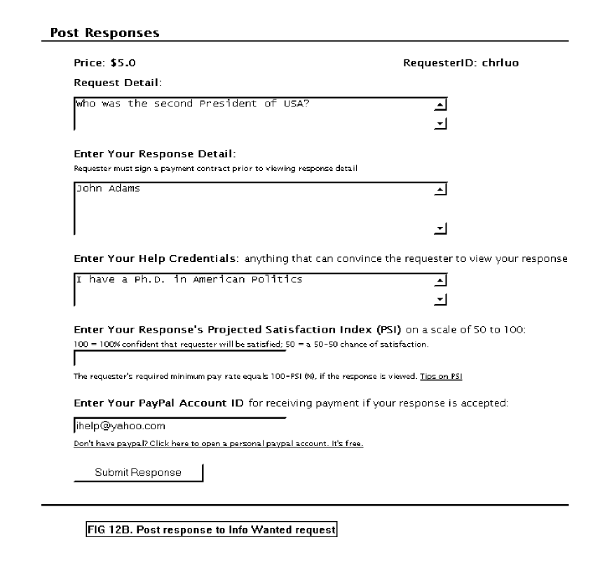

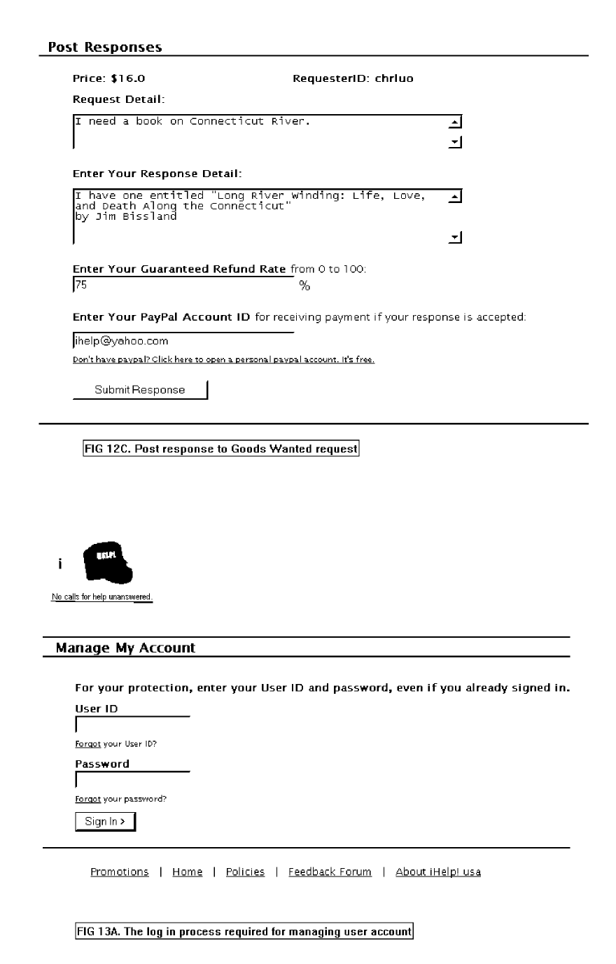

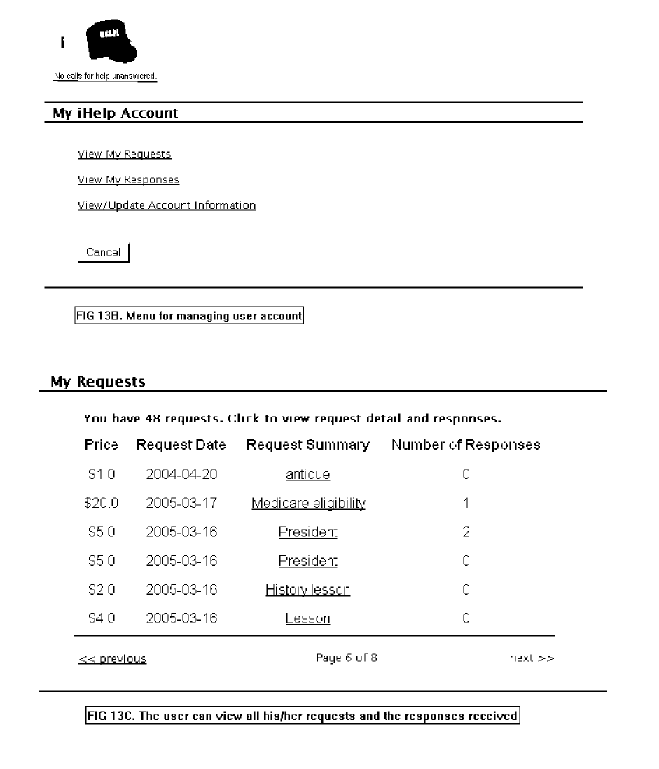

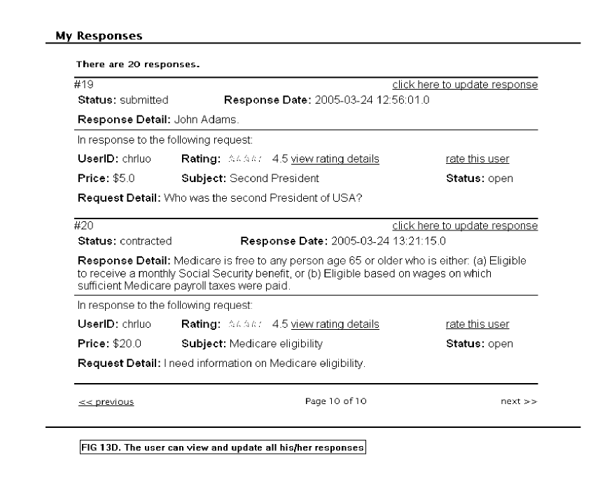

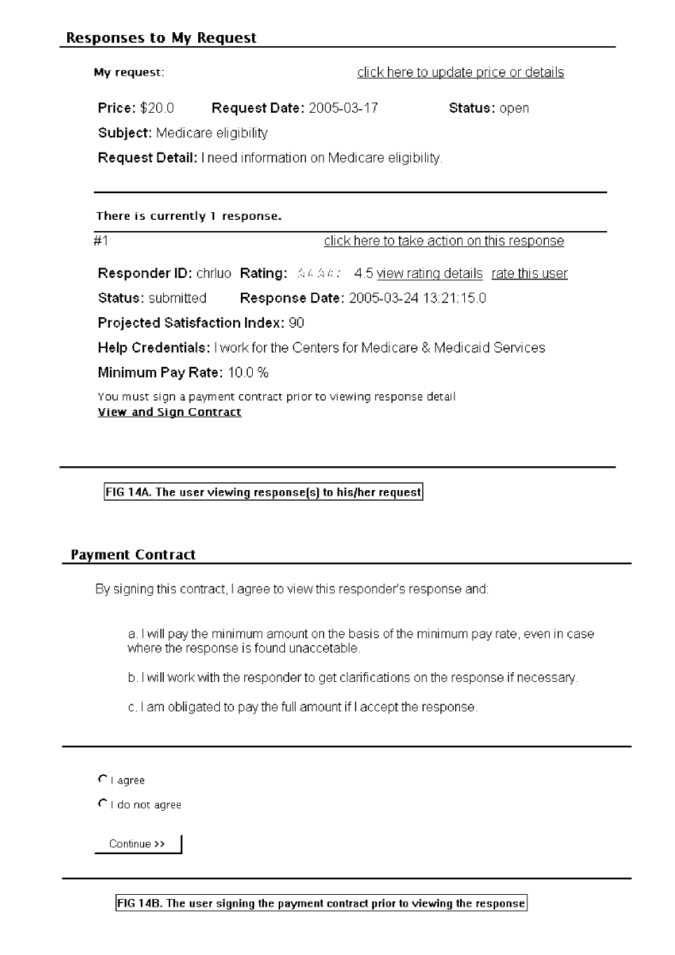

FIG. 13A-13D shows how users can manage the personal account in relation to their posted requests and responses, including viewing own requests, viewing own responses, and updating each of them. FIG. 14A shows the process of the user viewing a response to his/her request. From this page, they can also update the request (e.g., changing price, making clarifications, etc) and take appropriate actions on the response (accept, reject, etc). Note that for the Info Wanted requests, the requester must sign a payment contract prior to viewing the response details, as shown in FIGS. 14B and 14C.

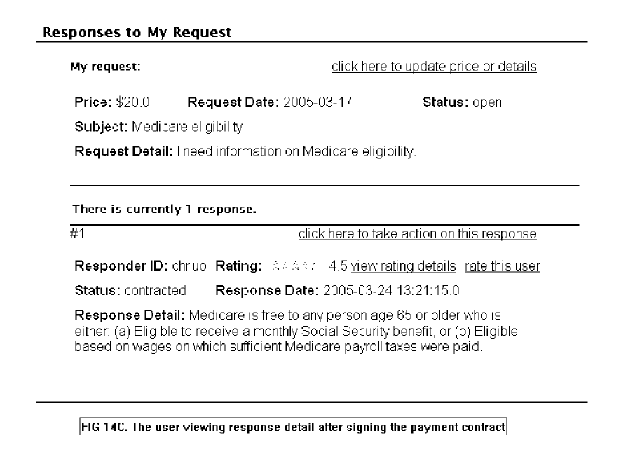

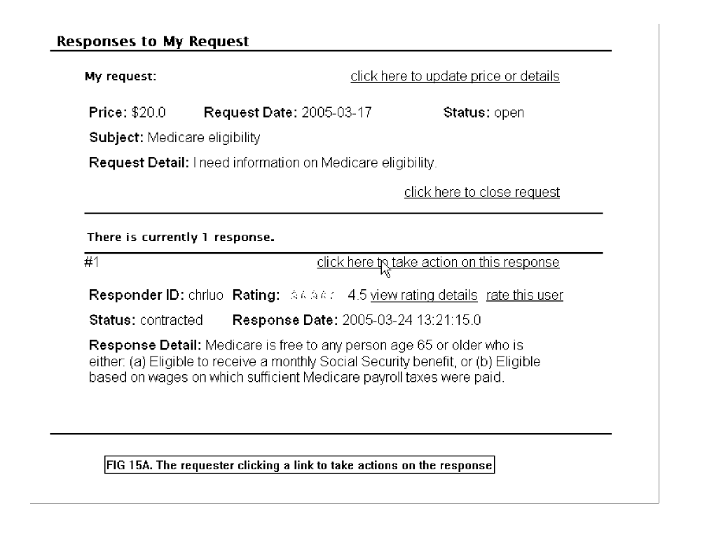

FIG. 15A-15B shows how a help requester takes actions (accept, accept conditionally, or reject) on each of the responses. A response can be accepted conditionally with conditions specified in the comment field. The requester is required to enter their reason for rejections in the comment field if a response is rejected.

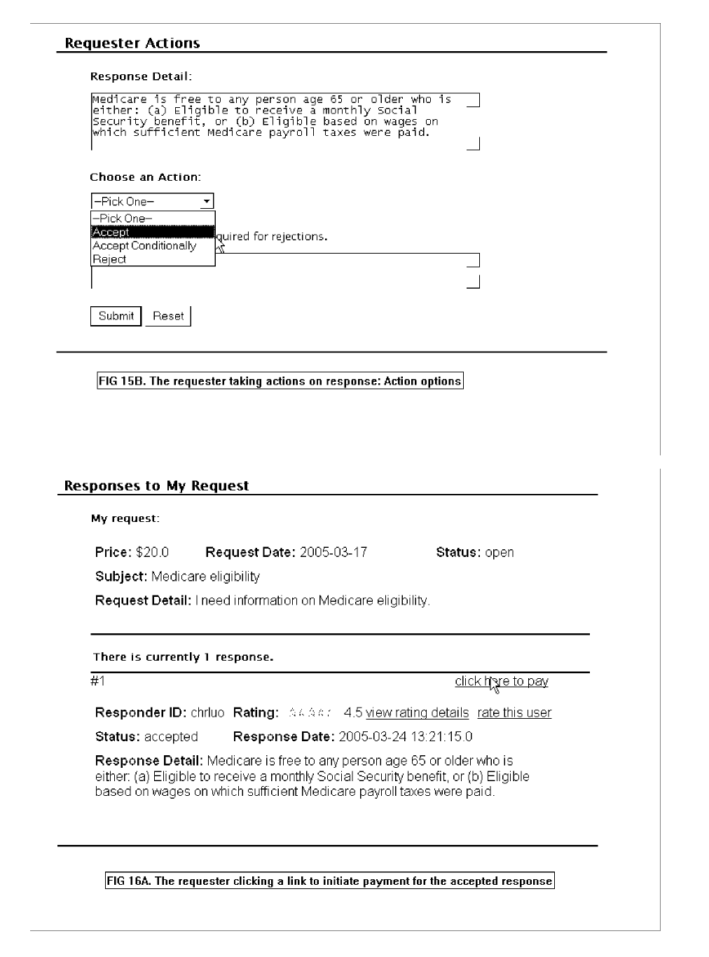

FIG. 16A-16C shows how a help requester uses the payment system to disburse payment to help providers after accepting their responses. In this embodiment, it involves using the PayPal account.

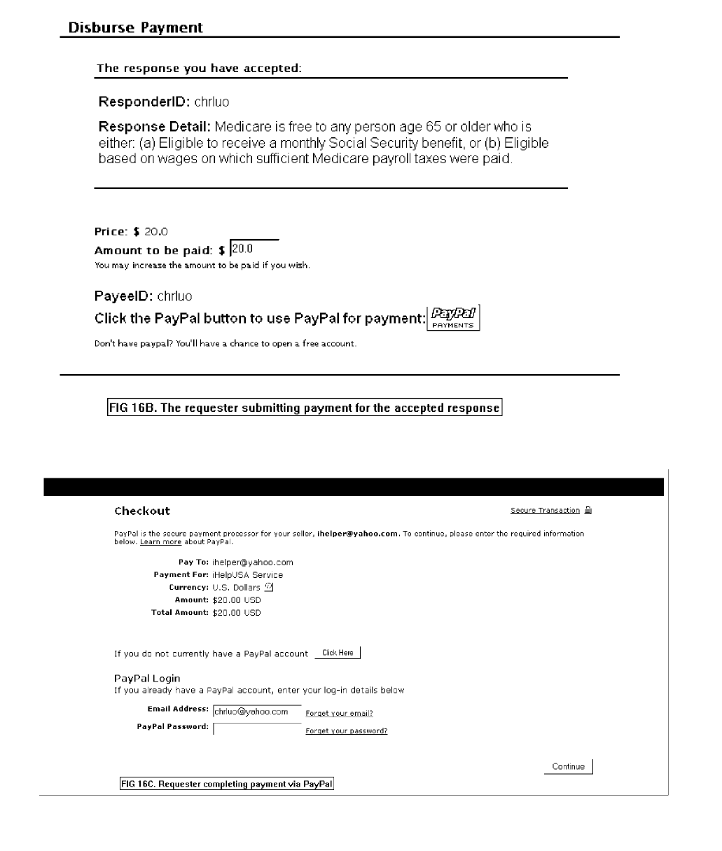

FIG. 17A-17B shows examples of the messaging system notifying users of their counterparts' activities regarding their requests or responses.

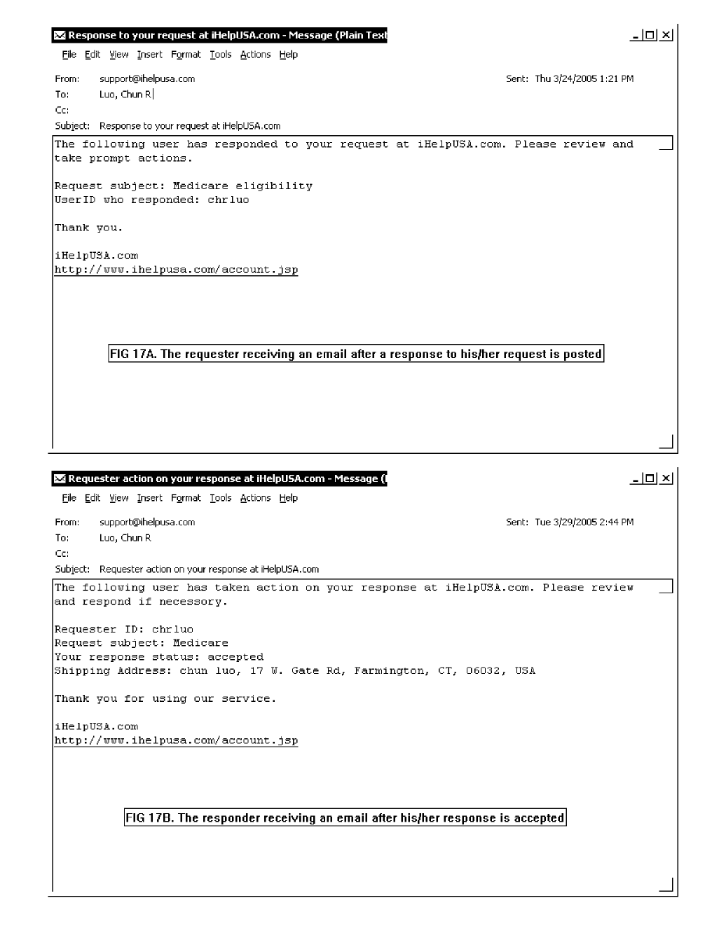

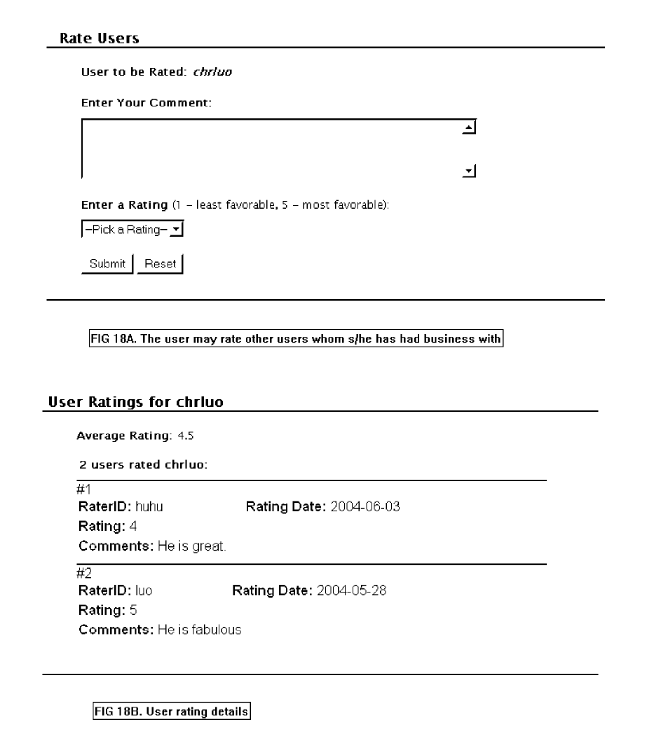

FIG. 18A-18C shows the peer rating process. Only users who have had business with each other can rate their counterparts. The rating system help regulate user behaviors and promote harmony and cooperation.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the application are not to be taken as the only possible embodiments.

Although the present invention has been described in terms of one preferred embodiment, it is not intended that the invention be limited to this embodiment. For example, two separate Web sites may be created, one for Goods Wanted help request and one for Info Wanted help request, respectively. Other embodiments will occur to those skilled in the art and are within the scope and spirit of the invention as defined by the claims that follow.

What is claimed is:

1. An integrated method and system for requesting and delivering help with goods and information via the Internet comprising:
a system for the user to post a help request, identified by request type (goods wanted or info wanted), request category within each type, the fees to be paid, and a detailed description of the request;
a system for help providers to search for open requests and post responses;
a system for both help requesters and providers to update their requests and responses;
a procedure for the help providers to enter a “guaranteed refund rate” to facilitate transactions involving merchandise;
a set of four methods and procedures to support the irreversible transaction involving information:
(a) a method and procedure for the help providers to derive a “projected satisfaction index” for their responses;
(b) a method and procedure for the help requester to calculate a “minimum pay rate” on the basis of the projected satisfaction index provided by the help provider;
(c) a procedure for the help providers to show their “help credentials” by entering anything that can increase the help requester's confidence in their responses;
(d) a method and procedure for the help requester to sign a “contract” with the help provider, prior to viewing his/her response. It requires that the requester pay a minimum amount on the basis of the minimum pay rate derived above, even if the response is eventually found unacceptable. The contract requires that the requester commit to working with the help provider in case a follow-up is needed for a complete resolution;
a system for the requester to accept, reject, or ask for further clarification on each of the responses received;
a payment system for the help requester to disburse payment to the help providers;
a messaging system to notify the help requester and provider regarding their counterparts' activities concerning the request;
a peer rating system for regulating user activities.

2. The system of claim 1 in which a buyer-initiated consumer-to-consumer (C2C) online marketplace is created comprising:
(a) a buyer who plays the role of help requester in the system of claim 1;
(b) a seller who plays the role of help provider in the system of claim 1.

3. The system of claim 1 in which a buyer-initiated C2C online marketplace for goods is created. This buyer-initiated marketplace differs from the seller-centered marketplace (e.g. eBay) where the sellers open their online stores and the buyers have to shop for what they need. Unlike a seller-centered marketplace, the buyers (i.e., help requesters) drive the market by initiating the transaction process and choosing among sellers (i.e., help providers) who respond to their requests for goods and information. It also differs from a buyer-initiated consumer-to-business (C2B) online marketplace (e.g., priceline.com) where participating merchants and retailers sell overstocked items or last minute services (e.g., airline tickets). Unlike a C2B marketplace, the buyer-initiated C2C marketplace is not limited to any particular industries or service areas since anyone can post a request for something and anyone who has that something can post a response to offer it to the requester. Besides differences in business models (C2C versus C2B), there are two other important differences in consumer behavior between this system and the Priceline's system. The first is the difference in buyers' goals. The buyers' primary goal in priceline.com is to find low-price items and save money, whereas the buyers' primary goal in this system is to find some special items they need or to save time (rather than money). The second difference concerns sellers' goals. The sellers' primary goal in priceline.com is to sell overstocked items or last-minute services, whereas the sellers' primary goal in this system is to help others out by providing used or no longer needed items.

4. The system of claim 1 in which a buyer-initiated C2C marketplace for information is created. This information marketplace covers virtually any topics or subject matters. For example, a client can request information on Medicare eligibility or seek legal help on a particular case. Or a client may seek answers to a personal or technical question on any topics or subject matters.

5. The system of claim 1 in which a method and procedure is developed for help providers to derive a “projected satisfaction index” for their responses to Info Wanted help requests. The projected satisfaction index is based on the help provider's own confidence rating of his or her response. The help provider is asked to indicate how confident his/her response will be correct (i.e., meet the requester's needs, solve their problem, etc) on a scale of 50 to 100, with 50 being 50-50 chance and 100 being 100% sure). They are told that this rating will determine a minimum pay rate the requester will have to pay if he/she decides to view this response.

6. The system of claim 1 in which a method and procedure is developed for the help provider to calculate a minimum pay rate on the basis of the projected satisfaction index provided by the help provider:
minimum pay rate=100−projected satisfaction index,
which means a minimum pay rate of 0 percent if the requester finds the response with a projected satisfaction index of 100 turns out to be unacceptable; a minimum pay rate of 25 percent if the response with a projected satisfaction index of 75 turns out to be unacceptable; and a minimum pay rate of 50 percent if the response with a projected satisfaction index of 50 turns out to be unacceptable. The minimum pay rate applies only to the case where a response is rejected. The help requester is obligated to pay the full amount (100 percent) if a response is accepted. The dynamics and the inverse relation between the projected satisfaction index and the minimum pay rate facilitate transactions involving information. It keeps the help providers from over-estimating the potential satisfaction of their responses. It reduces the risk of a help requester selecting and viewing the unwanted/incorrect responses.

7. The system of claim 1 in which a procedure is developed for the help provider to show their help credentials to convince the help requester that his or her response is correct or meets the need. The help provider is asked to enter anything in the “help credentials” field that can increase help requester's confidence in his/her response such as professional credentials, educational background, and work experience. In junction with the projected satisfaction index, it further reduces the risk of a help requester selecting and viewing the unwanted or incorrect responses.

8. The system of claim 1 in which a method and procedure is developed for the help requester to sign a “contract” with the help provider, prior to viewing his/her response. The contract requires the help provider to pay a minimum amount based on the minimum pay rate described above in case the response is deemed unacceptable, and to pay the full amount in case the response is accepted. The requester will not be able to sign another contract to view another response until the current contract is terminated by rejecting the current response and paying the minimum amount. The requester will need to detail their reasons for their rejections.
